(19) United States
(12) Patent Application Publication
(10) Pub. No.: US 2016/0232399 A1
(43) Pub. Date: Aug. 11, 2016

(54) SYSTEM AND METHOD OF DETECTING A GAZE OF A VIEWER

(71) Applicant: UMOOVE SERVICES LTD., Jerusalem (IL)

(72) Inventors: Yitzchak KEMPINSKI, Geva Binyamin (IL); David ASULIN, Beit Horon (IL); Zehava LASKER, Beit El (IL); Sophia FRIJ, Maale Adumim (IL); Ronen HARATI, Ra'anana (IL)

(21) Appl. No.: 14/680,372

(22) Filed: Apr. 7, 2015

Related U.S. Application Data
(60) Provisional application No. 61/976,529, filed on Apr. 8, 2014.

(51) Int. Cl. G06K 9/00; G06T 7/00; G06K 9/52; G06T 7/60; G06F 3/01; G06T 7/20

(52) U.S. Cl. CPC G06K 9/0061; G06K 9/00604; G06F 3/013; G06K 9/00268; G06T 7/20; G06K 9/52; G06T 7/60; G06T 7/0042; G06K 9/00617; G06T 2207/30201

(57) ABSTRACT

A method of determining a point or object on a digital display that is being gazed at by a viewer by capturing an image of the viewer's iris and at least one other feature of the viewer's face, calculating an imaginary line from the objet being viewed, to the iris and continuing to an imaginary center of the viewer's eye, then calculating a position of the center of the eye relative to the other feature of the viewer's face. Upon a change in the position of the eye and the iris, a calculation can be made of the position of the center of eye relative to the other feature, and a position of the iris in a second image. An imaginary line can be extended out from the center of the eye, through the new position of the iris on onto the to the digital display to determine the point of gaze of the viewer.

### CROSS REFERENCE TO RELATED APPLICATIONS

This application claims benefit from U.S. Provisional Patent Application 61/976,529 filed on Apr. 8, 2015 and entitled System and Method of Detecting a Gaze of a Viewer, incorporated herein by reference.

### BACKGROUND

Content presented for viewing by a user may include items that are within the view of the user. For example, a single screen on an electronic display may include one or more text items, one or more images, and one or more graphics. Though all of such items may be presented for viewing, there may be a desire to know whether the viewer actually viewed such items, which ones were viewed and for how long. Further, various physical maladies and indications may be accompanied by or result in changes or variations in the capacity of a viewer to track, view, or follow an item in the field of view of the viewer.

### BRIEF DESCRIPTION OF THE DRAWINGS

FIG. 1A schematically illustrates a gaze detection system, according to some embodiments of the invention;

FIG. 1B schematically illustrates a cross-sectional view of an eyeball of a viewer, according to some embodiments of the invention;

FIG. 2 shows a flow diagram for identifying objects on an electronic display, according to some embodiments of the invention;

FIG. 3 shows a flow diagram for identifying a point that is being viewed, according to some embodiments of the invention;

FIG. 4A shows a flow diagram for detecting a change in location of a facial feature, according to some embodiments of the invention;

FIG. 4B shows a flow diagram for identifying an object that is the subject of a gaze, according to some embodiments of the invention;

FIG. 5A shows geometric representation of angles in a field of view of the viewer, according to some embodiments of the invention;

FIG. 5B shows geometric representation of angles in the field of view of the viewer for determination of pupil's location along the ‘Z’ axis, according to some embodiments of the invention;

FIG. 5C shows geometric representation of angles in the field of view of the viewer for determination of pupil's location along the ‘Y’ axis, according to some embodiments of the invention;

FIG. 6 shows geometric representation of the line of sight between the viewer and the camera, according to some embodiments of the invention;

FIG. 7 shows geometric representation of angles and distances for the pupil of the viewer, according to some embodiments of the invention;

FIG. 8 shows geometric representation of an angle between the nose-bridge to camera and to left eye corner of the viewer, according to some embodiments of the invention;

FIG. 9, which shows geometric representation of an angle of head rotation of the viewer around the ‘Y’ axis, according to some embodiments of the invention;

FIG. 10, which shows geometric representation of an angle of head rotation of the viewer around the ‘X’ axis, according to some embodiments of the invention;

FIG. 11A shows geometric representation for new vectors from the camera to the center of each eyeball of the viewer during calibration, according to some embodiments of the invention;

FIG. 11B shows geometric representation for new vectors from the camera to the center of each eyeball of the viewer after head rotation, according to some embodiments of the invention;

FIG. 12 shows geometric representation for the angle between the camera to the center of the eyeball and the center of the eyeball to the iris of the viewer, according to some embodiments of the invention; and

FIG. 13, which shows geometric representation for the viewer's point of gaze, according to some embodiments of the invention.

### EMBODIMENTS OF THE INVENTION

To better understand the present invention and appreciate its practical applications, the following figures are provided and referenced hereafter. It should be noted that the figures are given as examples only and in no way limit the scope of the invention. Like components are denoted by like reference numerals.

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a non-transitory computer or processor readable medium, or a computer or processor storage medium, such as for example a memory, a disk drive, or a USB flash memory or other non-volatile memory, encoding, including or storing instructions, e.g., computer-executable instructions, which when executed by a processor or controller, carry out methods disclosed herein.

When used in this document, a viewer may, in addition to its regular meaning, refer to a person or animal that is looking at or that is situated in a position to look at a display, screen, object, or object shown on a screen.

When used in this document, and in addition to its regular meaning, an iris or pupil may mean or include an area of one or more eyes of a viewer that includes an area of a pupil and iris or such portion of the pupil as may be covered or uncovered in the dilation and constricting of the iris. In some embodiments a differentiation between the iris and the pupil may not be required such that an entire area encompassed by the iris may be included. A center of the iris may include a geometric center of the iris or some other point within the pupil or one or more eyes.

When used in this document, and in addition to its regular meaning, the term center of the eye ball may refer to an actual geometric center of one or more eyeballs of a viewer. Alternatively or in addition, it may refer to an estimate of a center of an eyeball of a user or to some other point or area identifiable in three dimensional space within one or more eyeballs of a viewer relative to one or more other points or locations of a body part of the user. In some embodiments, a center of an eyeball may refer to one or more points within an eyeball that may be found on an imaginary line passing from an object on a display and through an iris of a viewer, or vice versa. In some embodiments, a radius of an eyeball may be assumed to be 1.25 to 1.3 centimeters. Other estimates or assumptions about a radius or shape of an eyeball may be used or applied based on an estimated physical characteristics of a user or population of users. In some embodiments such radius may not be an actual geometric radius of an eyeball, but rather a distance or vector from an iris to a center of the eyeball.

When used in this document, and in addition to its regular meaning, the term detecting may refer to one or more processes of establishing a presence of an object or part of an object such as a head, face, nose, eyes, eye corners or other body parts within a field of view of camera or in an image. Detecting may also include one or more processes of finding a location and/or angle of one or more of such objects relative to one or more of such other objects and/or relative to one or more of an electronic display screen or an object displayed on a screen or relative to a camera. In some embodiment such location of the detected part may be captured as coordinates or angles of one or more axis such as an X, Y or Z axis (where Z axis may refer to a distance or vector of an object relative to one or both of camera and screen). The term tracking may, in addition to its regular meaning, include one or more processes of finding a location and/or angle of one or more of objects in one or more images, series of images or images captured over a time period, and/or determining a change in a location of such object between such images. In some embodiments a result of a detection or tracking of a gaze may yield one or more coordinates or values indicating positions, locations or objects that a viewer is viewing at a particular time, in the course of a series of captured images or at other intervals. In some embodiments a result of tracking may be translated or interpreted into a pattern of movements of one or more eyes. In some embodiments a tracking may trigger a change in one or more objects that appear on a display or screen. For example, in some embodiments a gaze tracking may indicate that a viewer is looking at or following a particular object on a screen over a given number of frames or captured images of the viewer. Such tracking, and the objects or locations that the user is viewing at some time in the present or in the past, or that the user may be looking at, may be recorded in a memory and/or may be manifested in a change in a depiction of the object being viewed or in some other object. For example, if a user is gazing at an object displayed on a screen, a processor may issue a signal to highlight, expand, enlarge or reduce the objet that is the subject of the gaze. Other manifestations, triggers, or actions to be taken in response to a detection or tracking of an object by a viewer may be implemented.

When used in this document, the term ‘gaze’ or ‘point of gaze’ may, in addition to its usual meaning, indicate or identify a process of looking at, studying, glancing at, or focusing on an object, text, image, graphic, area or, with respect to an electronic display, a pixel or group of pixels that is being looked at or followed by one or more eyes of a viewer. A gaze of a viewer may be relevant for a particular time period. For example, a viewer may have gazed at a displayed object for a consecutive number of seconds, or for a number of seconds over a period when a particular object appeared on the screen. A gaze of a viewer may be relevant for a particular object or for a class of objects. For example, a gaze or a person may be tracked as he looks at an apple or at an apple displayed on a screen. A gaze of a person may be tracked as the person looks at various circular objects or dog depictions on a screen, or on depictions of other objects or classes of objects.

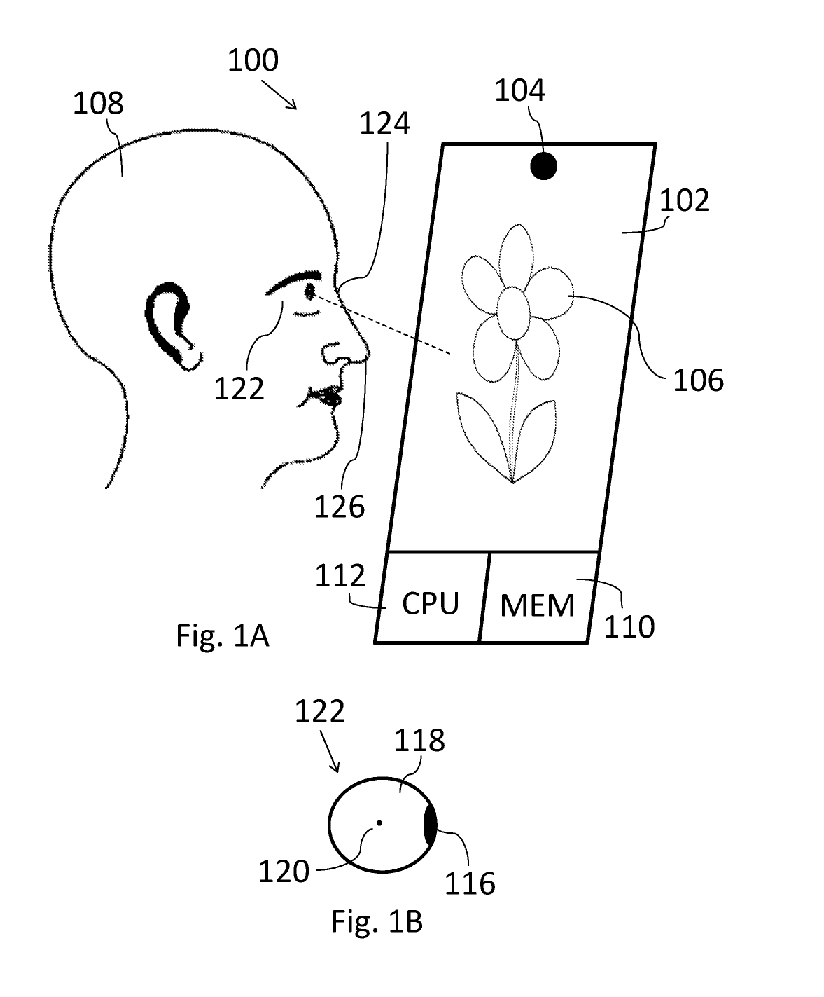

Reference is made to FIG. 1, a diagram of a system in accordance with an embodiment of the invention. System 100 may include an electronic display screen 102 and a camera 104, imager or image capture sensor. Camera 104 may be at a known distance, location and angle to screen 102, and from a content 106 displayed on screen 102. Screen 102 may display content 106 such as for example text, images or graphics or other items which may be viewed by a user 108 or viewer. Such content 106 may be still or video and may move or be moved on screen 102. System 100 may be associated with one or more mass data storage memory 110 units and a processor 112. In some embodiments, camera 104 may be or include an imaging device suitable to capture two-dimensional still or video images using visible light. Camera 104 and screen 102 may be included in a mobile device such as a cellular telephone, tablet computer, laptop computer or other mobile device. Camera 104 and screen 102 may be associated with a fixed or non-portable device such as a workstation or desktop computer. Other configurations are possible.

In operation, embodiments of the invention may detect and track a head, face, eye(s), corner(s) of eyes, nose, bridge of nose or other body part of a viewer in one or more images that are captured by camera 104. A position of one or more irises 116 of a viewer may be detected and tracked. An estimate may be calculated of a position of the center of one or more eyeballs 118 by calculating the vector between the point of calibration (such as camera 104 or another known point) and the iris 116 or the center of the area detected as the iris 116 in the image, and continuing such vector to a center 120 of the eyeball 118 based on an estimated eyeball radius.

A position, location or vector of such center 120 of an eyeball 118 may be calculated relative to a position, location or vector of the body part that is also being tracked, such as an eye corner 122 or bridge of nose 124 or edge of nose. A position of such as eye corners 122 and/or bridge of a nose 124 and/or nose edge may be tracked in one or more images. A vector, position or location of the eyeball center 120 may be calculated after giving effect to the tracked changes in position of the eye corners 122 or nose bridge 124 or nose edge. A position or location of the iris 116 as was determined or calculated from the iris tracking, on the one hand, and a position of the eyeball center 120 as was calculated from the tracking of eye corners 122/nose bridge 124 and the known position of the eyeball center 120 relative to such eye corners 122/nose bridge 124/nose edge, allows an imaginary line or vector to be calculated from the eyeball center 120, through the iris 116 and further to the content 106 on the screen that is the subject of the gaze.

Embodiments of the invention may include a system that has an imager suitable to capture using visible light two dimensional images of an iris and of a facial feature of a viewer, where the imager is at a known position relative to objects being displayed on an electronic display. Embodiments of such system may include a processor to determine that one of the object is being viewed by said viewer at a certain or defined time. In some embodiments, the imager and the display may be or include a mobile imager, a mobile display, such as those that may be included in a cellular telephone, smartphone, tablet computer, laptop computer or other electronic devices. Embodiments of the invention may be used to detect that a viewer is looking at a real world object, where the real world object is at a known distance and position relative to for example an imager.

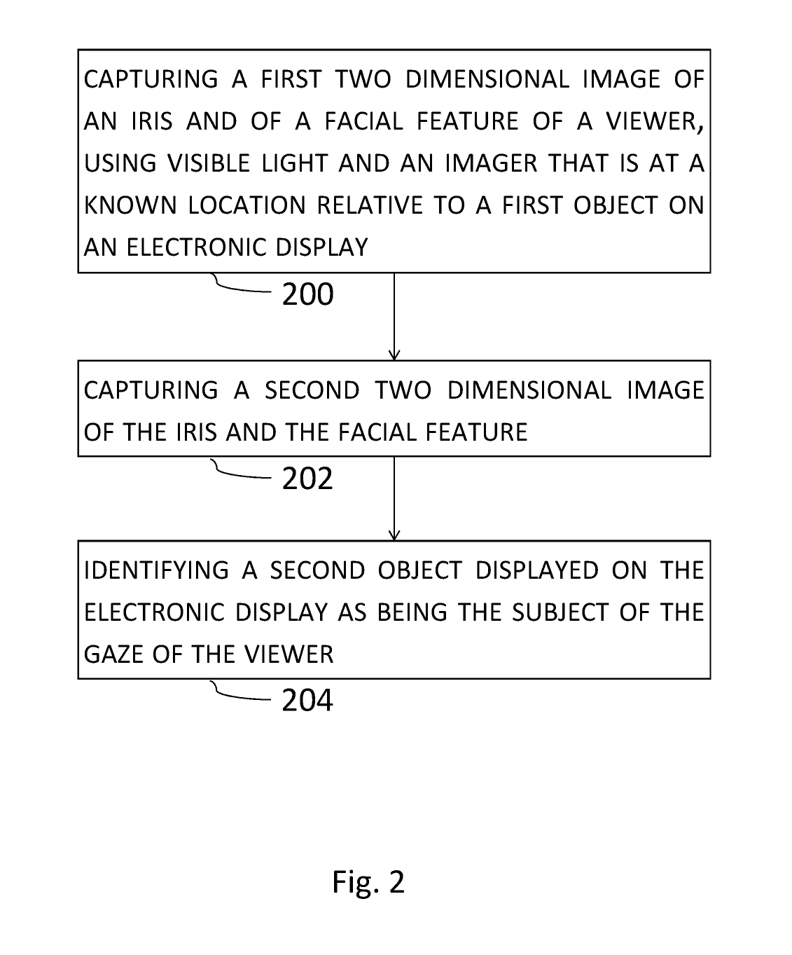

Reference is made to FIG. 2, a flow diagram in accordance with an embodiment of the invention. Embodiments of the invention may include a method, which as is shown in block 200, includes capturing a first two-dimensional image of an iris and a facial feature of a viewer, using visible light by way of an imager that is at a known location or position relative to a first object on an electronic display. In block 202, a method may include using the imager to capture a second two-dimensional image of the iris and the facial feature. In block 204, a method may include identifying a second object displayed on the electronic display as being the subject of a gaze of viewer. In some embodiments the objects may be displayed on a display of a mobile device and the imager may be connected to the mobile device.

In some embodiments, a method may include calculating a change in location of the iris and the facial feature between the first image and the second image.

In some embodiments, a method may include calculating a location of a point inside of an eye of the viewer, where such point is on a vector from the first object that passes through the iris.

In some embodiments, a method may include calculating a location of the point inside the eye of the viewer relative to a location of the facial feature.

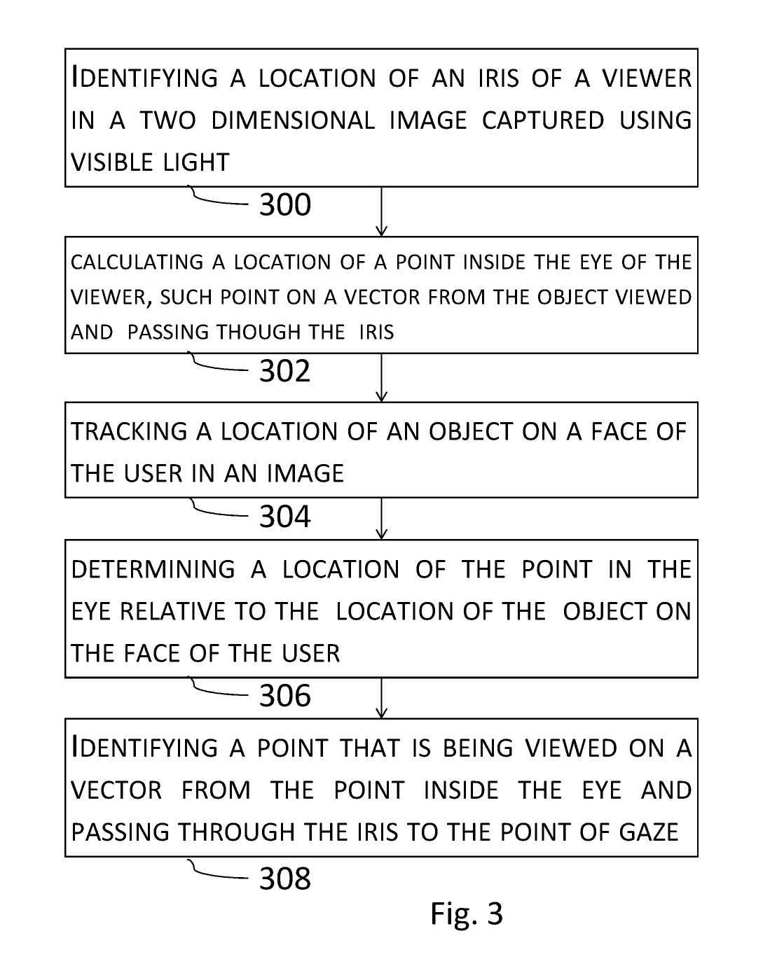

Reference is made to FIG. 3, a flow diagram in accordance with an embodiment of the invention. Embodiments of the invention may include a method, which as is shown in block 300 includes Identifying in a two-dimensional image of a viewer captured using visible light, a location of an iris of the viewer relative to a location of the imager. The imager is at a known location relative to an object viewed by the viewer. In block 302, the method may include calculating a location of a point inside the eye, such point on a vector from the object viewed by the viewer, and passing though the iris. In block 304, the method may include tracking a location of an object on a face of the user, as such face is captured in an image by the imager. In block 306, the method may include determining a location of the point in the eye relative to the location of the object on the face of the user. In block 306, the method may include identifying the point of gaze on a vector from the point inside the eye and passing through the iris to the point of gaze. In some embodiments, the imager may be a mobile imager and the object viewed by the viewer may be displayed on a mobile device connected to the imager.

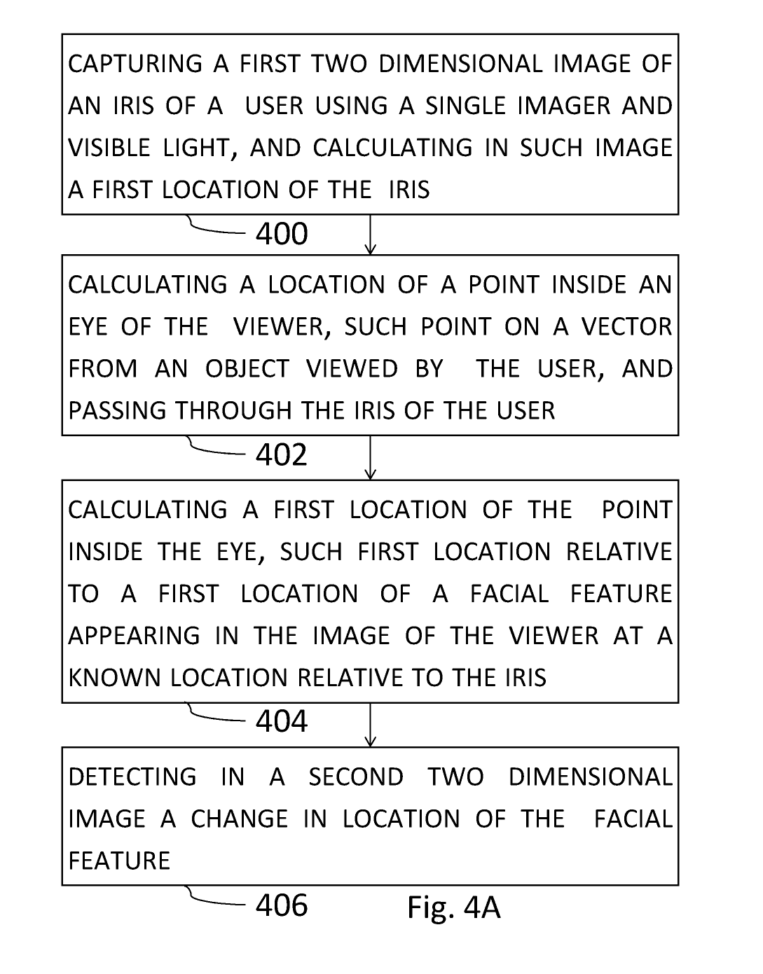

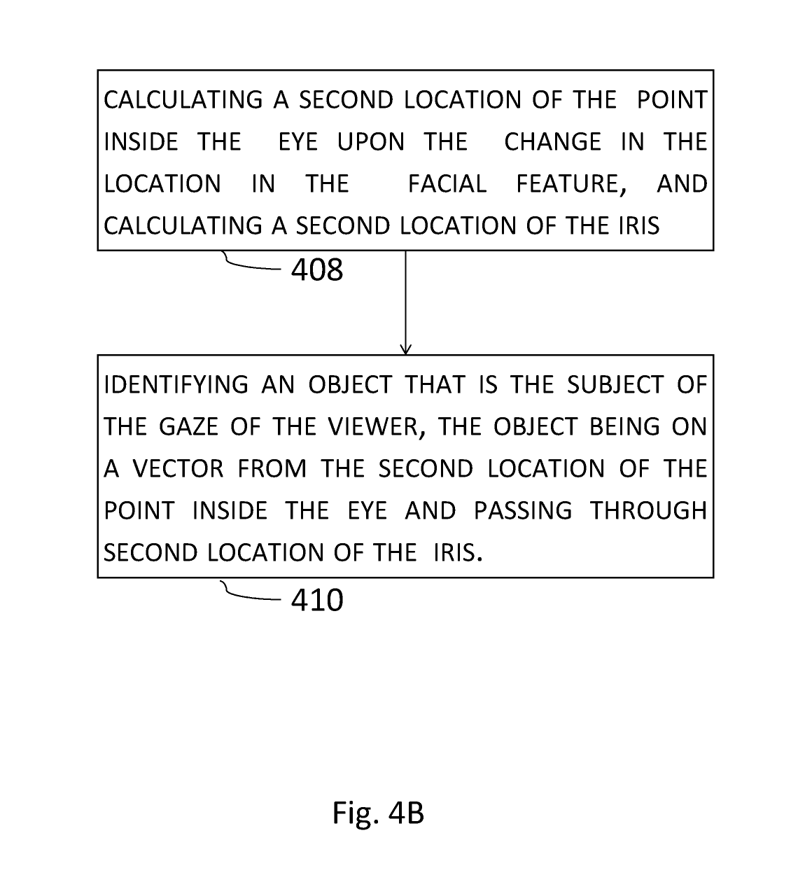

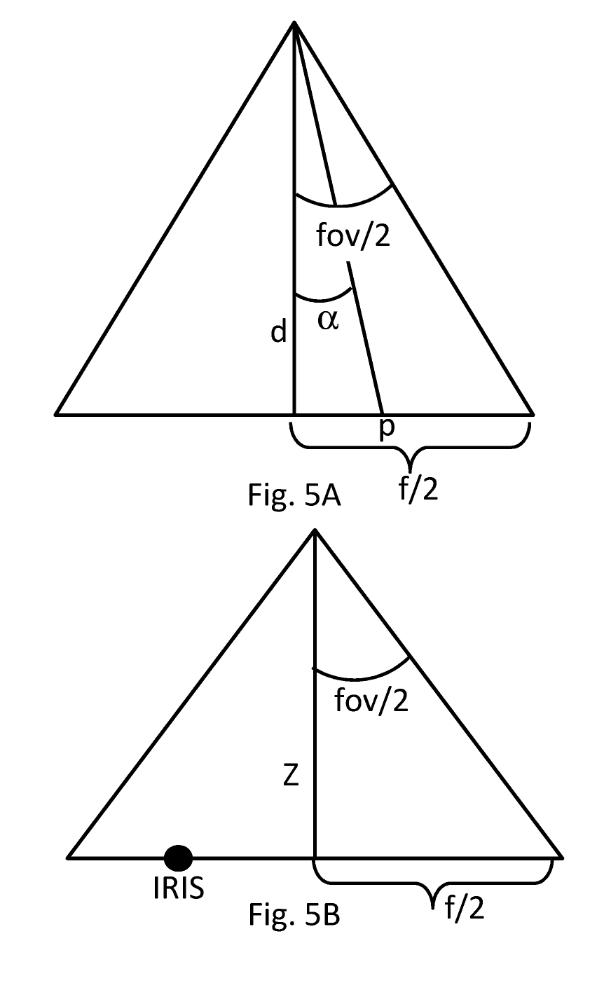

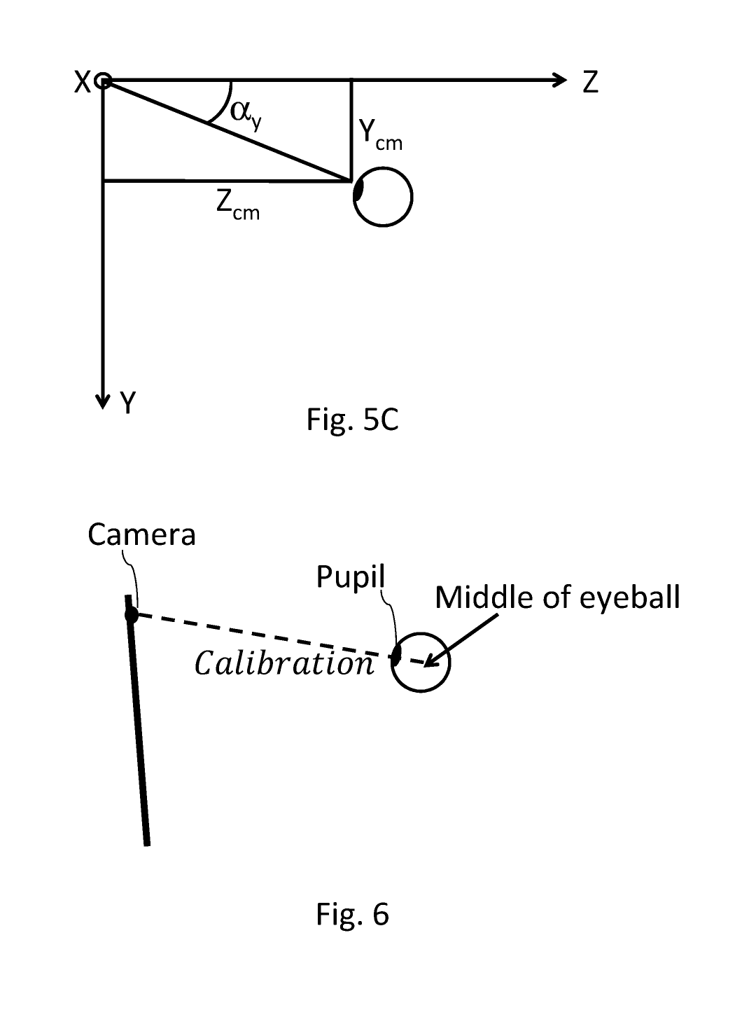

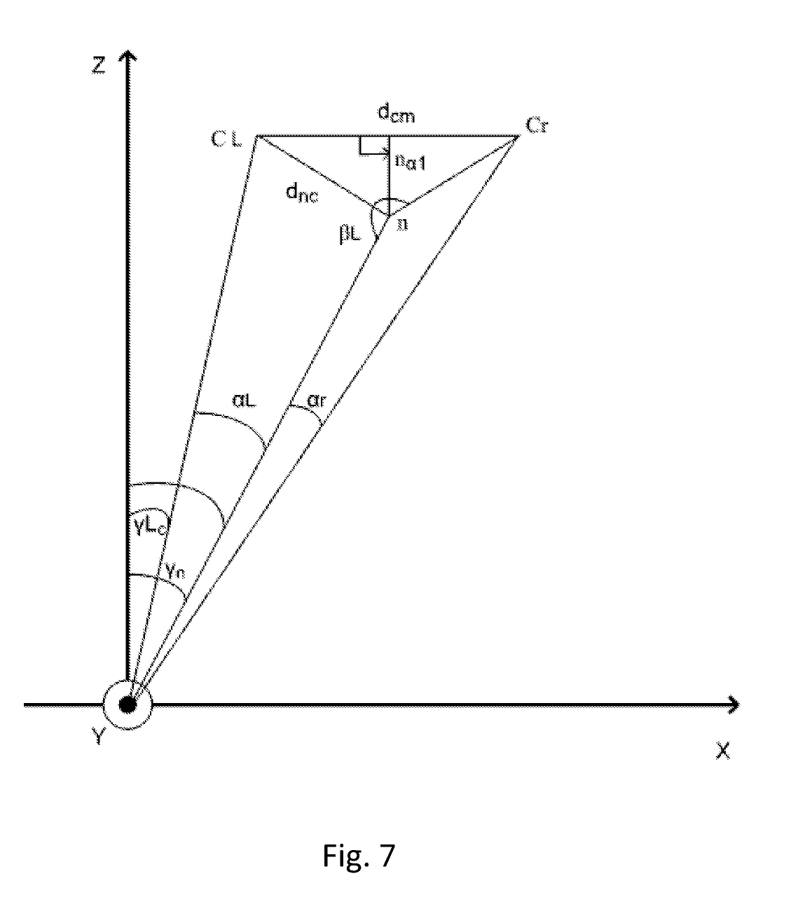

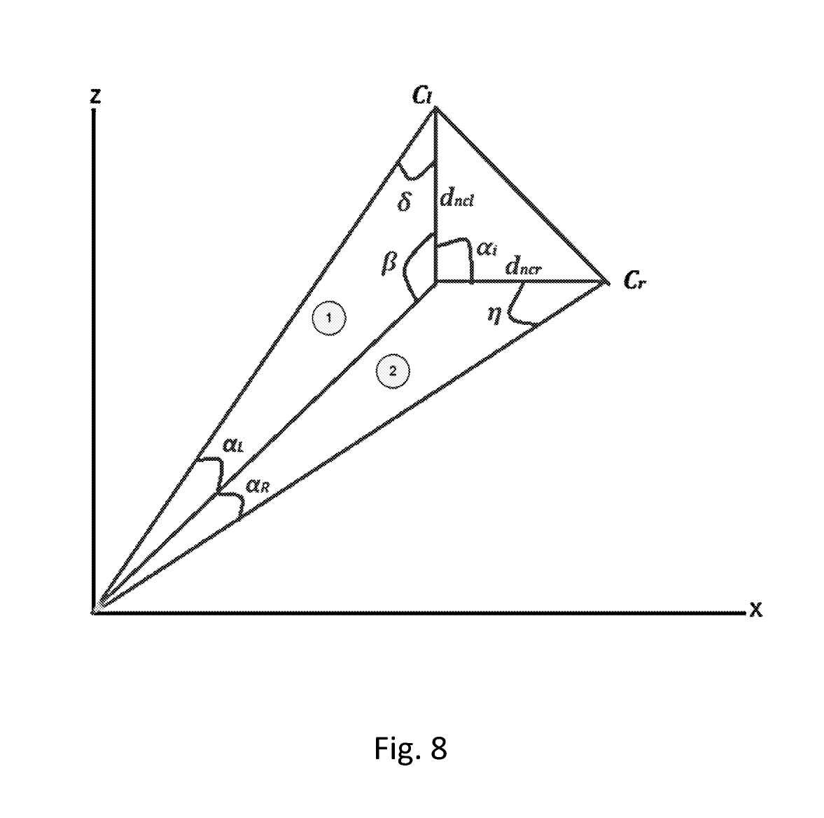

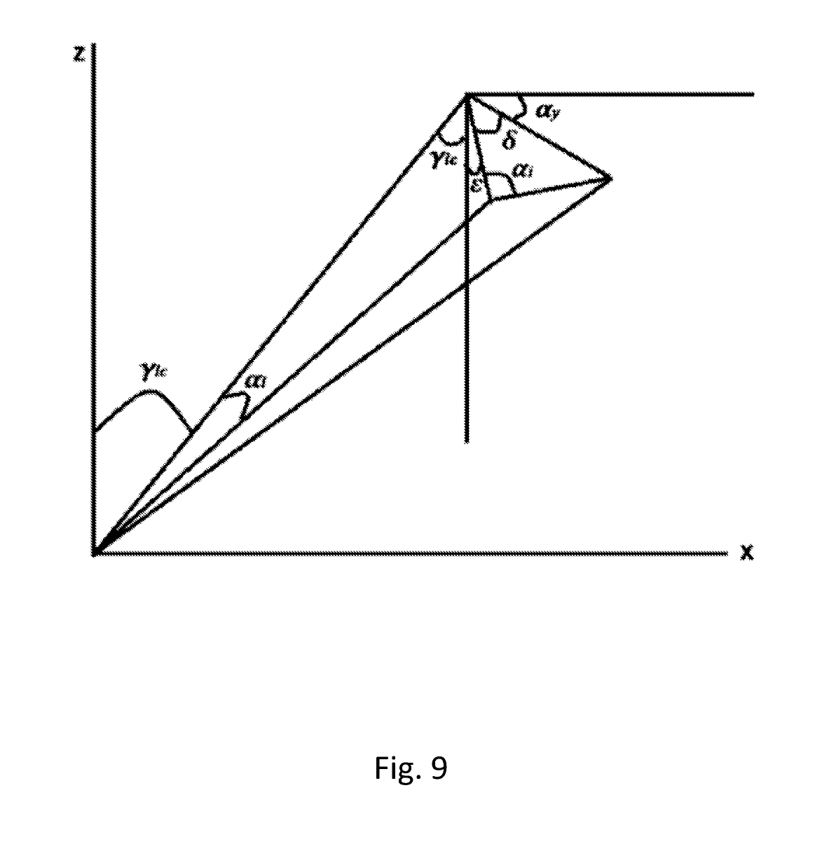

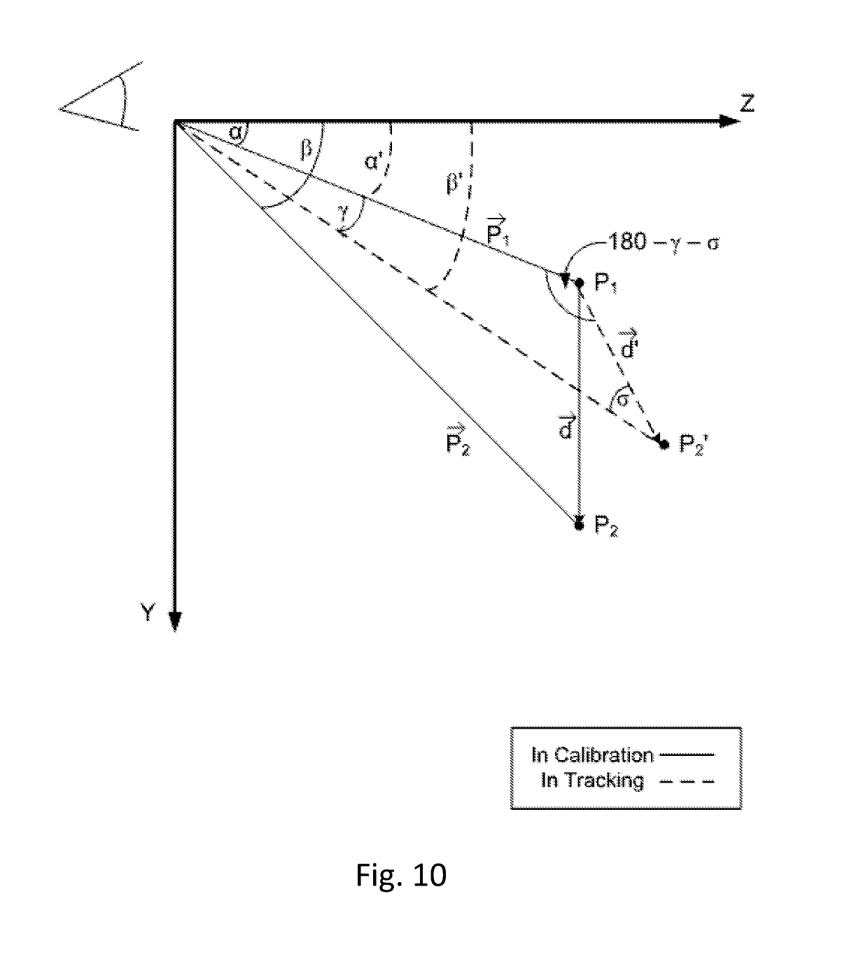

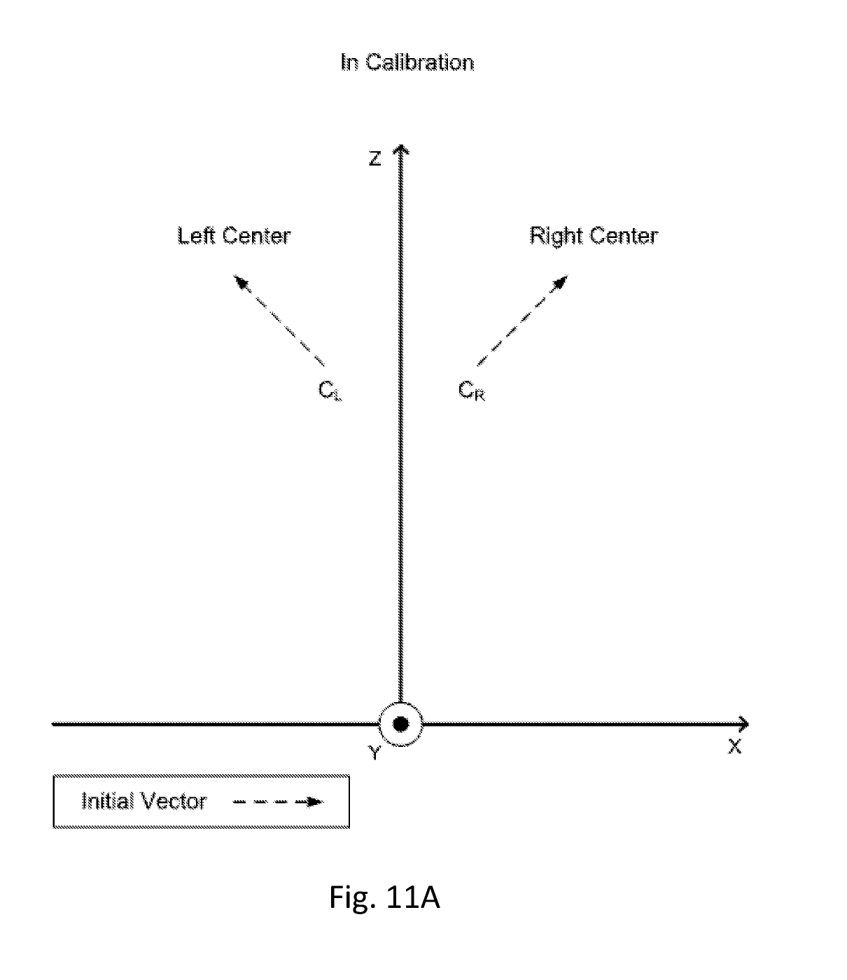

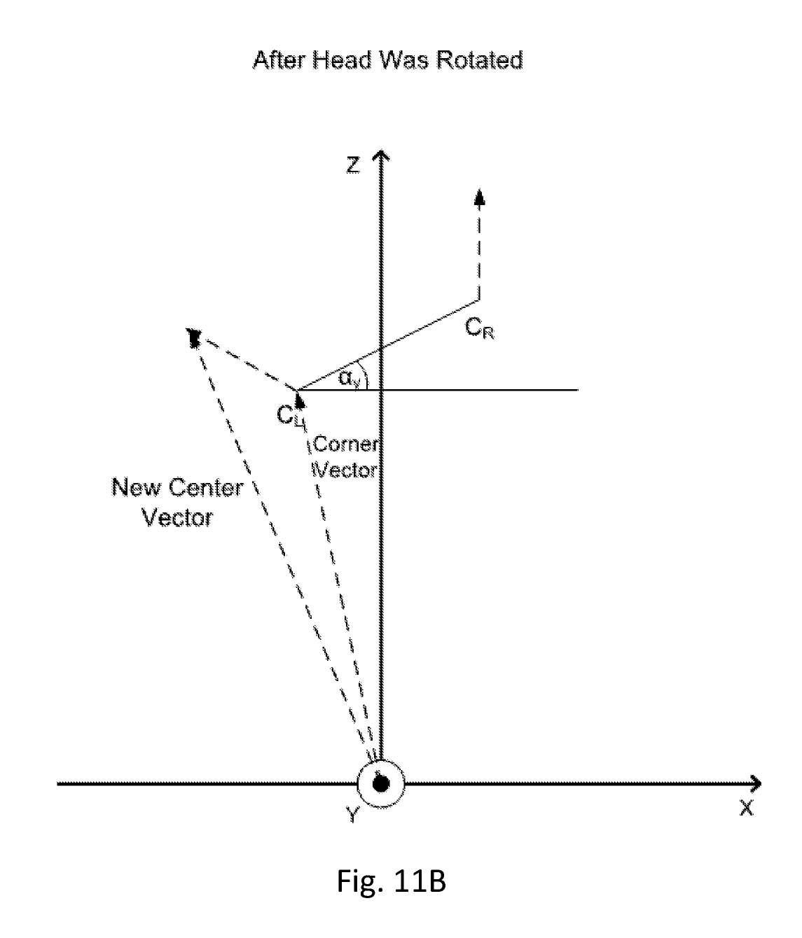

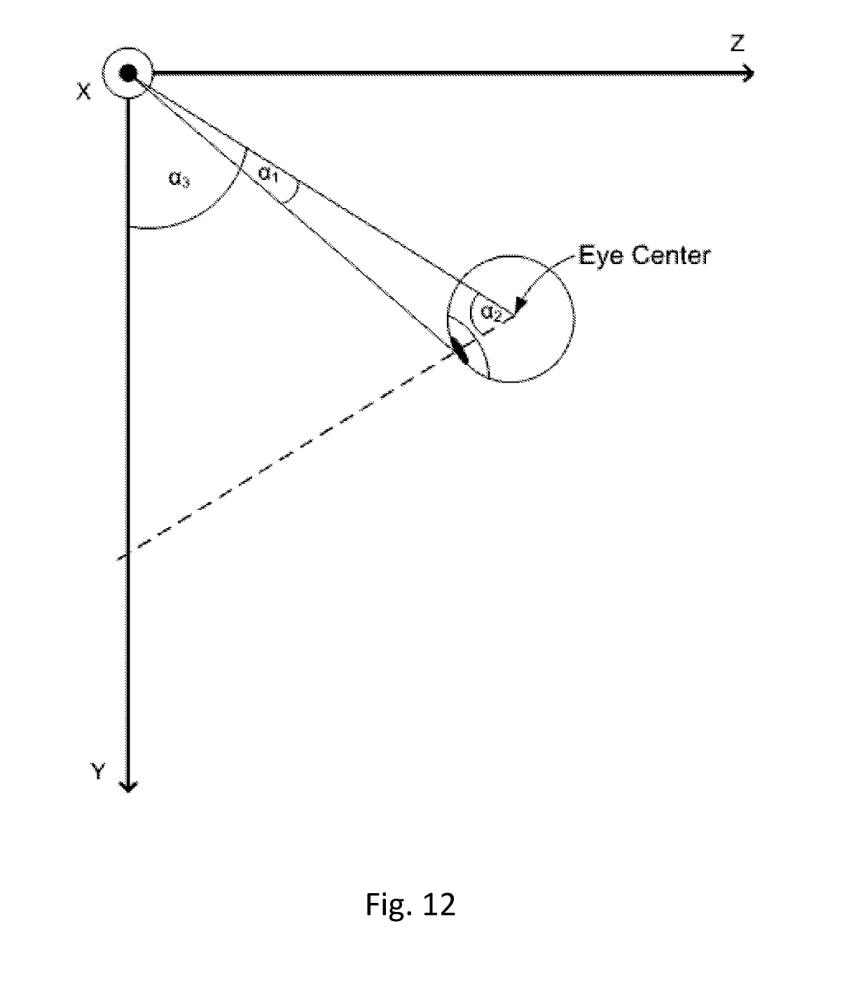

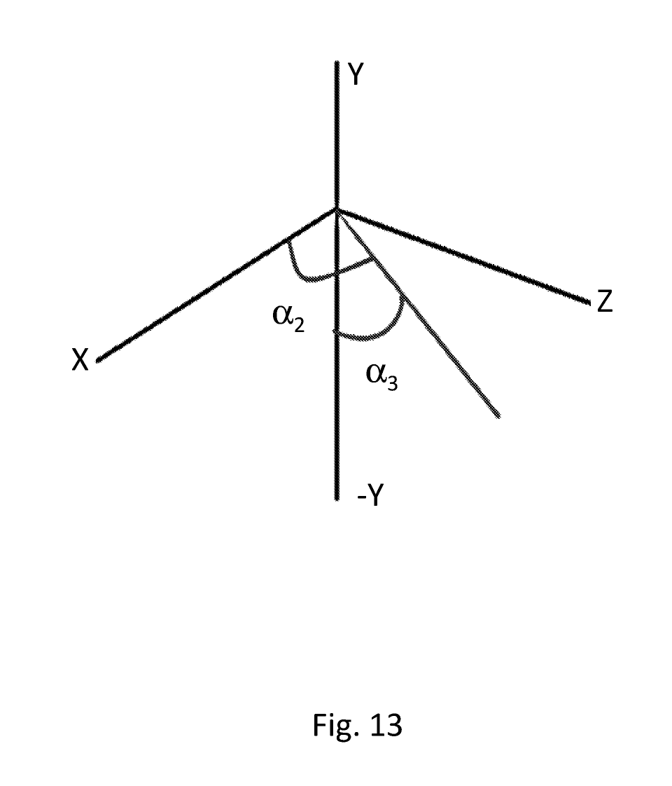

Reference is made to FIG. 4, a flow diagram in accordance with an embodiment of the invention. Embodiments of the invention may include a method of identifying an object that is the subject of a gaze of a viewer, which as is shown in block 400 may include capturing a first two-dimensional image of an iris of a user, using a single imager and visible light, and calculating a first location of the iris. As is shown in block 402, the method may include calculating a point inside an eye of the viewer, such point on a vector from an object viewed by the user, and passing through the iris of the user. As is shown in block 404, the method may include calculating a first location of the point inside the eye, such first location relative to a first location of a facial feature of the viewer that is at a known location relative to the iris. As is shown in block 406, the method may include detecting in a second two dimensional image a change in location of the facial feature. As is shown in block 408, the method may include calculating a second location of the point inside the eye upon the change in the location in the facial feature, and calculating a second location of the iris. As is shown in block 410, the method may include identifying an object that is the subject of the gaze of the viewer, the object being on a vector from the second location of the point inside the eye and passing through second location of the iris.

Face detection: Face/Eye detection may be performed using for example the Viola-Jones face or eye detection algorithm with the OpenCV Cascade-Classifier object.
1. There may be derived two eye region areas (or other areas) from the detected face for face tracking

### 1.1.1 Face Tracking:

1. Track the position of the eye regions (or other tracked area of a face or head) using tracking algorithms such as described in the document attached hereto as Exhibit A entitled A Method of Optimizing Size and Position of a Search Window of a Tracking System or other methods.
2. In some embodiments it may be possible to reach higher resolution/accuracy by detecting and tracking eye corners (see below) following the tracking of the eye regions to correct/improve the position of the eye regions.
   1.2 Locating the iris in the frame

### 1.2.1 Iris Detection:

An iris and a size of an iris may be detected and calculated in an image or series of images using the methods described in the documents attached hereto as Exhibit B and entitled Eye Tracking and in Exhibit C entitled SYSTEM AND METHOD FOR MEASURING PUPIL SIZE AND SPACING WITH 2D CAMERA or using other methods.

### 1.2.2 Iris Tracking:

Via a phased search where a subsequent phase may rely on the results of a prior phase, track the iris. At the end of the search, we may add a validation stage to validate the result:
1. Darkest:
   Search area—If the previous search gave a good result (accepted by the validation stage), the new search area will be based on the previous locations with a small shift of 0.2D, 0.3D (where D is the iris diameter). Otherwise, we build a search area based on the last eye corner location(s), search area size will be approximately 3D×2D (where D is the iris diameter).
   Search method—Find the darkest area which approximates the size of the iris. While giving weight to the prominence of the locations relative to its surrounding values.
2. Template:
   Search area—based on the outcome of the previous stage, if there was a small movement with a shift of 0.1D, 0.15D otherwise with a shift of 0.2D, 0.3D (where D is the iris diameter).
   Search method—Find a circular shape that has the iris diameter (taking into account that some part of the circle may not be visible) whose edges have the sharpest dark to light value transitions.
3. Accurate:
Search area—based on the outcome of the previous phase with a shift of up to 0.07D (where D is the iris diameter).
Search method—sample edge points while giving more weight to the inner side being dark and limiting to an estimated distance between the points on both sides of the iris based on an the iris center as detected in the template stage. We use these points to match a circle via the Weighted Least Squares algorithm while constraining the algorithm with the last known diameter. This process can be done on an enlarged search window using bicubic interpolation to reach sub-pixel level of values as well as comparing the edge pixel to the pixels on each side to determine what percentage of the edge pixel is occupied by the iris. For example, where the edge of the iris/pupil occupies only part of a complete pixel in an image, a change in the portion of the pixel that is so occupied by the iris or a change in the percentage of the pixel that is so occupied by the iris may be detected. Such change may be interpreted as a movement of the iris.
4. Validator: Disqualify results with for example, the following features or results:
   a. Generates an eye distance that is significantly larger than the previous eye distance.
   b. Generates an eye angle that is significantly larger than the previous eye angle. (The eye angle is the slope between the two eyes)
   c. Generates an iris value mean difference that is significantly larger than the last.

### 1.3 Locating the Eye Inner Corners in the Frame

### 1.3.1 Eye Corner Detection:

1. Face detection using for example Viola-Jones face detection algorithm with the OpenCV Cascade-Classifier object.
2. In an area derived from the detected face area and based on the Iris locations, we search for optional corners in the area of the eyes closer to the center of the face using corner detection algorithms such as the OpenCV's Harris corner detection, or other detection processes.
3. Select the most appropriate pair of corners filtering out the pairs wherein the angle between the line that connects the corners to the line that connects the iris centers is too large. Choose the pair by giving each a score according to a list of parameters among which are:
   a. The distance between each iris or eye area to the eye corner should be similar. (assuming that the viewer is looking forward)
   b. Darker points will get a higher score
   c. Stronger Harris points will get a higher score
   d. A smaller angle between the line connecting the irises and the line connecting the corners will get a higher score

### 1.3.2 Eye Corner Tracking:

1. From the detection process store the following:
   a. The distance between the irises;
   b. The distance between the eye corners;
   c. The angle between the line connecting the irises and the line connecting the corners (If the lines are parallel the angle will be zero);
   d. In areas to the side of the detected iris areas store two templates containing each of the eye's inner corners (the template areas occupy less space of the eye and more of the nose);
2. In the new frame, check what happened to the distance between the irises, and apply the same change to the distance between the corners. In addition, make sure that the angle between the line connecting the irises to the line connecting the corners did not change.
3. Define small search windows based on the face tracking result and the position of the corners in the last frame relative to the face tracking results in the last frame.
4. Using the Sum of Absolute Differences (SAD) algorithm or Sum of Difference (SSD), search for an area similar to the template (since both corners move together and we have their new ratio) taking into account the positions in the last frame, the frame preceding five frames and the first frame, or other sets of past frames.
5. We may add a sub-pixel level of the corner tracking by the process being done on an enlarged search window using for example bi-cubic interpolation in addition to or instead of comparing SAD/SSD results on both sides of the detected corner and evaluating to which side the corner is more similar and at what percentage.
6. Calculate the movement from the found template area to the last template area, this is the inner corner's movement.
7. Apply this correction to the tracking of the eye regions.
8. Store the new Templates

### 1.4 Nose Bridge/End—Detection and Tracking

1. Nose Bridge—Find the lightest Y value area between the eyes, in accordance with a method described on Exhibit C or by some other method
Track that area by searching for the lightest Y value area in a position relative to the eye region tacking position
2. Nose End—detection and tracking
Define a peak strip template where the center of the strip is lighter than the sides of the strip.
Between the two irises search for the lightest peak strip, then go a pixel down and search again for the lightest peak strip there. do this until the horizontal distance from the found peak point and the last peak point is larger than a predefined threshold
Slope line: find the line of best fit—a straight line equation that is closest to all the found peak points
In the direction of the slope line search for the nose end strip with a high light to dark difference.
Track the nose end strip area by searching in a smaller area around the last location according to the head/eye strip movement.

### 1.5 Converting the Frame Pixels of an Object to Angles

f—frame's width/height.
fov—camera's field of view corresponding to the frame's width/height.
α—the angle between the z axis and the object location on the x/y axis.
p—the object's location in the frame.
d—the distance from the camera

$$tan ( \frac{fov}{2} ) = \frac{( \frac{f}{d} )}{2} ⇒ d = \frac{f}{2 tan ( \frac{fov}{2} )}$$

$$tan ( α ) = \frac{( \frac{f}{2} ) - {p}_{y}}{d} = \frac{( \frac{f}{2} - p ) ( 2 tan ( \frac{fov}{2} ) )}{{f}_{h}} \\ ⇒ α = arctan ( \frac{( \frac{f}{2} - p ) \cdot 2 tan ( \frac{fov}{2} )}{f} )$$

### 2 Overview

1. Detect position of the user's irises and eye corners.
2. Estimate the position of the eyeball center based on the vector between the point of calibration (such as the camera or another known point) and the iris center, and continuing that vector based on an estimated eyeball radius or distance to a designated point within the eyeball.
3. Track the position of the iris.
4. Track the position of the eye corners and nose bridge and calculate the new position of the eyeball center.
5. Calculate the new vector between the eyeball center and the iris center.
6. Estimate the point of gaze on the device screen.

### 3 Calibration

### 3.1 Set a Pixel to Cm Ratio

Find the size of an iris in pixels and set a pixel:centimeter (cm) ratio that is dependent on the user's position relative to the camera:

$$ratio = \frac{{iris}_{cm}}{{iris}_{px}}$$

Assuming an average general population iris size (1.18 cm).

This can be done with other features of a known size of the general population or the specific user.

### 3.2 Determine the Center of the Pupil

Determine the center of the pupil in centimeters in three-dimensional space. Location is determined by the location of the pupil in the frame:

### Define:

x, y, z—the pupil location relative to the camera.
f—frame's width/height.
fov—camera's field of view corresponding to the frame's width/height.
αₓ—the angle between the z axis and the iris's location on the x axis.
α_{y}—the angle between the z axis and the iris's location on the y axis.
p—the iris's location in the frame.
1. Find the pupil Z location via the camera's fov:

$$tan ( \frac{{fov}_{w}}{2} ) = \frac{( \frac{{f}_{w}}{2} )}{Z} ⇒ {Z}_{cm} = \frac{{f}_{w}}{2 tan ( \frac{{fov}_{w}}{2} )} \cdot ratio$$

2. Find the pupil Y location via:
   calculate α_{y} via Converting the user's location on the y axis to angles (see 1.5 above)

$${α}_{y} = arctan ( \frac{( \frac{{f}_{h}}{2} - {p}_{y} ) \cdot 2 tan ( \frac{{fov}_{h}}{2} )}{{f}_{h}} )$$

$${Y}_{cm} = tan ( {α}_{y} ) \cdot {Z}_{cm}$$

3. Do the same on the X axis and you'll get:

$${α}_{x} = arctan ( \frac{( \frac{{f}_{w}}{2} - {p}_{x} ) \cdot 2 tan ( \frac{{fov}_{w}}{2} )}{{f}_{w}} )$$

$${X}_{cm} = tan ( {α}_{x} ) \cdot {Z}_{cm}$$

3.3 Determine the Vector from the Camera to the Middle of the Eyeball

Determine the middle of eyeball in three-dimensional space by calibrating the user with the camera. This is done by adding the eye ball radius towards the calibration direction to the middle of the pupil when the user is looking at the camera.

### Define:

eb—eye ball vector. Vector from the camera to the middle of the eye ball.
p—pupil vector. Vector for the camera to the center of the pupil.
r—eye ball radius vector. A vector with the eye balls radius and direction of the pupil vector. (Eyeball estimation is 1.25 cm)

e\vec{b}=\vec{p}+\vec{r}

### 3.4 Determine Nose Bridge and Eye Corner Angles and Distances

### Define:

c—left/right eye corner location in the frame.
h—nose bridge height in cm—the nose bridge height distance from the face—a constant of 1.5 cm (use other constants for other populations).
d_{clcr}—distance between corners on the x axis in cm.
αᵢ—angle between nose bridge—left corner and nose bridge—right corner.
d_{nc}—distance between nose bridge and corner.

### 3.4.1 Distance Between the Two Eye Corners

Calculate the distance between the two eye corners on the x axis in cm

d_{clcr}=(c_{r,x}−c_{l,x})·ratio

### 3.4.2 Angle Between the Nose Bridge to the Eye Left Corner and Nose Bridge to the Right Eye Corner

Calculate the angle between the line connecting the nose bridge and the eye left corner and the line connecting the nose bridge and the right eye corner.

$$tan ( \frac{{α}_{i}}{2} ) = \frac{( \frac{{d}_{clcr}}{2} )}{h} \\ ⇒ {α}_{i} = 2 \cdot arctan ( \frac{{d}_{clcr}}{2 \cdot h} )$$

### 3.4.3 Distance Between the Nose Bridge and Each Corner Point

We can use the Pythagorean theorem to calculate the distance between the nose bridge point and each corner point:

$${d}_{nc} = \sqrt{{( \frac{{d}_{clcr}}{2} )}^{2} + {h}^{2}}$$

### 4 Tracking the Gaze

### 4.1 Find New Middle of Pupil

Find new middle of pupil in the next frame using iris tracking (see 1.2.2 above).

### 4.2 Angles and Distances

Calculate angles and distances in order to find the new eye corner vectors

### Define:

c—left/right eye corner location in the frame.
n—nose bridge (point between the eyes) location in the frame.
γₙ—angle between z axis and nose bridge.
γ_{lc}—angle between z axis and left corner.
γ_{rc}—angle between z axis and right corner.
αₗ—angle between camera-nose bridge and camera-left corner.
αᵣ—angle between camera-nose bridge and camera-right corner.
d_{clcr}—distance between corners on the x axis in cm (calculated in calibration).
d_{nc}—distance between nose bridge and corner (calculated in calibration).
d_{clc}—distance between camera and left corner.
h—nose bridge height in cm—the nose bridge height distance from the face—a constant of 1.5 cm.
αᵢ—angle between nose bridge —left corner and nose bridge —right corner (calculated in calibration).
βₗ—angle between nose bridge —camera and nose bridge —left corner.
α_{y}-angle of head rotation around y axis.
α_{z}-angle of head rotation around z axis.

### 4.2.1 Angle Between the Z Axis and Nose Bridge, Left Eye, Right Eye

1. Calculate the angle the angle between the z axis and nose bridge:

$${γ}_{n} = arctan ( \frac{( \frac{{f}_{w}}{2} - {p}_{x} ) \cdot tan ( \frac{{fov}_{w}}{2} ) \cdot 2}{{f}_{w}} )$$

2. Calculate the angle the angle between the z axis and the left eye corner:

$${γ}_{lc} = arctan ( \frac{( \frac{{f}_{w}}{2} - {c}_{l , x} ) \cdot tan ( \frac{{fov}_{w}}{2} ) \cdot 2}{{f}_{w}} )$$

3. Calculate the angle the angle between the z axis and the right eye corner:

$${γ}_{rc} = arctan ( \frac{( \frac{{f}_{w}}{2} - {c}_{r , x} ) \cdot tan ( \frac{{fov}_{w}}{2} ) \cdot 2}{{f}_{w}} )$$

### 4.2.2 Angle Between the Nose Bridge to Camera and the Eye Corners to Camera

1. Calculate the angle between the line from the nose bridge to the camera and the line from the left eye corner to the camera:

αₗ=γₙ−γ_{lc}
2. Calculate the angle between the line from the nose bridge to the camera and the line from the right eye corner to the camera:

αᵣ=γ_{rc}−γₙ

### 4.2.3 Angle Between the Nose Bridge to Camera and the Nose Bridge to Left Eye Corner

In order to calculate β, angle between the line connecting the nose bridge and the camera to the line connecting the nose bridge to the left eye corner, let's define the angles we don't know with α and β:

δ=180−αₗ−β

η=β+αᵢ−180−αᵣ

Using the law of sines:

$$\frac{F}{sin ( 180 - {α}_{l} - β )} = \frac{{d}_{ncl}}{sin ( {α}_{l} )} \\ ⇒ \frac{F}{{d}_{ncl}} = \frac{sin ( 180 - {α}_{l} - β )}{sin ( {α}_{l} )}$$

$$\frac{F}{sin ( β + {α}_{i} - 180 - {α}_{r} )} = \frac{{d}_{ncr}}{sin ( {α}_{r} )} \\ ⇒ \frac{F}{{d}_{ncr}} = \frac{sin ( β + {α}_{i} - 180 - {α}_{r} )}{sin ( {α}_{r} )}$$

Assuming the nose bridge point is the center point between the eyes,

$${d}_{ncl} = {d}_{ncr} ⇒ \frac{F}{{d}_{ncl}} = \frac{F}{{d}_{ncr}} \\ ⇒ \frac{sin ( 180 - {α}_{l} - β )}{sin ( {α}_{l} )} = \frac{sin ( β + {α}_{i} - 180 - {α}_{r} )}{sin ( {α}_{r} )}$$

solving this equation will result with the following:

$${β}_{l} = ar cos ( \frac{\frac{sin ( {α}_{l , x} )}{sin ( {α}_{r , x} )} \cdot cos ( PI - {α}_{l , x} ) + cos ( {α}_{i} - {α}_{r , x} - PI )}{\sqrt{\frac{{sin ( {α}_{l , x} )}^{2}}{sin ( {α}_{r , x} )} + 2 \cdot \frac{sin ( {α}_{l , x} )}{sin ( {α}_{r , x} )} \cdot cos ( {α}_{i} - {α}_{r , x} - {α}_{i , x} ) + 1}} )$$

### 4.2.4 Angle of Head Rotation Around y Axis

To calculate the angle of head rotation around y axis, lets draw a line from the left eye corner that's parallel to the X axis and a line that's parallel to the Z axis. The head rotation angle around the y axis is the angle between the line parallel to the X axis and the line connecting the two eye corners. To calculate that angle well do the following:

$$δ = \frac{180 - {α}_{i}}{2}$$

$$ɛ = 180 - {α}_{l} - {β}_{l} - {γ}_{lc , x}$$

$${α}_{y} = 90 - \frac{180 - {α}_{i}}{2} - ( 180 - {α}_{l} - {β}_{l} - {γ}_{lc , x} )$$

$${α}_{y} = \frac{{α}_{i}}{2} - 180 + {α}_{l} + {β}_{l} + {γ}_{lc , x}$$

### 4.2.5 Distance Between the Camera and the Left Corner

Calculate the distance between the camera and the left corner by using the law of sines:

$$\frac{{d}_{clc}}{sin ( {α}_{i} )} = \frac{{d}_{nc}}{sin ( {α}_{l} )} ⇒ {d}_{clc} = \frac{{d}_{nc} \cdot sin ( {α}_{i} )}{sin ( {α}_{l} )}$$

### 4.2.6 Calculate the Head Rotation Around the X-Axis

In order to find the rotation around the X axis we may track a point in addition to the eye corners, for example beneath the nose, who rotates around the X axis when the head rotates. Given the angles between the camera and both tracking points on the Y-axis, and the real difference between these points we may calculate the rotation around the X-axis.

define:

p1—the center point between the eye corners

p2—the nose end

α—the angle from the camera to the point between the eye corners in calibration

β—the angle from the camera to the nose end in calibration

α′—the angle from the camera to the point between the eye corners in the next frame

β′—the angle from the camera to the nose end in the next frame

l1—the distance from the camera to the point between the eye corners

l2—the distance from the camera to the nose end in the next frame

d—the vector from the center point between the eye corners and the nose end

d′—the vector from the center point between the eye corners and the nose end in the next frame

γ—the angle between the center point between the eye corners and the nose end in the next frame

σ—the angle between d and l2

according to the law of sines:

$$\begin{matrix}\frac{\vert {l}_{1} \vert}{sin σ} = \frac{\vert {d}^{′} \vert}{sin σ} ⇒ σ = arcsin \frac{\vert {l}_{1} \vert}{\vert {d}^{′} \vert} & I ) \\ \frac{\vert {l}_{2} \vert}{sin ( 180 - σ - γ )} = \frac{\vert {d}^{′} \vert}{sin γ} \\ ⇒ \vert {l}_{2} \vert = \frac{\vert {d}^{′} \vert sin ( 180 - σ - γ )}{sin γ} & II ) \\ γ = {α}^{′} - {β}^{′} & III ) \\ ⇒ {\vec{d}}^{′} = {\vec{l}}_{2} - {\vec{l}}_{1} & IV )\end{matrix}$$

The angle of the d vector that we calculated gives us the angle of rotation around the X-axis.

4.3 New Vectors from the Camera to Each Eye

Find the new vectors from the camera to each eye using the angles and distances. Left eye corner:

x_{cm}=sin(γ_{l,x})·d_{clc}

z_{cm}=cos(γ_{l,x})·d_{clc}

y_{cm}=tan(γ_{l,y})·z_{cm}

Same applies to the right eye corner using the right angles.

4.4 New Vectors from the Camera to the Center of Each Eyeball

Calculate the new vectors from the camera to the center of each eyeball using the corner vectors and corners angle with the x axis.

This is done by rotating the initial vectors from the eye corners to the center of the eye balls around the y axis by α_{y} and around the z axis by α_{z}, and adding it to the vectors from the center of the camera to the eye corners

### 4.5 Angle Between the Camera to Center of the Eyeball and the Center of the Eyeball to the Iris

Calculate the angle between the line connecting the camera and the center of the eyeball and the line connecting the center of the eyeball to the iris, using the law of sin s.

### Define:

α₁—angle between camera—center eye and camera—iris.
α₂—angle between camera—center eye and center eye—iris.
d₁—distance between camera and eye center.
eye_{cm}—eye ball radius in cm.

$${α}_{2} = 180 - {α}_{1} - arcsin [ \frac{{d}_{1} \cdot sin ( {α}_{1} )}{{eye}_{cm}} ]$$

### 4.6 User's Point of Gaze

Find the user's point of gaze on the device in cm, using the law of sines

### Define:

α₃—angle between the line connecting the camera and the center of the eyeball and the negative y axis.

left eye point of gaze:

$${x}_{cm} = \frac{sin ( {α}_{2 , x} ) \cdot {d}_{1 , x}}{sin ( PI - {α}_{2 , x} - {α}_{3 , x} )}$$

$${y}_{cm} = \frac{sin ( {α}_{2 , y} ) \cdot {d}_{1 , y}}{sin ( PI - {α}_{2 , y} - {α}_{3 , y} )}$$

do the same to get the right eye point of gaze.

Convert point of gaze in cm relative to the camera to point of gaze in pixels on the screen based on the position of the camera to the origin of the screen's pixels axis and based on the screen pixel to cm ratio.

In some embodiments, as part of or following a calibration, coordinates, vectors and associations vectors between the eye-corners and eye ball centers or other face features may be stored so that a face pose (distance between eyes, distance between eyes and nose nostrils or mouth) is available in a database on a device or on a server. Such data may be associated with face recognition data or other personal log in data so that next time face recognition may pull face right data from the database, and quickly assemble relationships between eyeball centers and face coordinates. In some embodiments a log-in to an application on a device or to a social network page may allow an access to such data as may be stored

In some embodiments, use of average values for vectors between eye-corners and eye ball centers may provide sufficient estimates of the gaze angle even without calibration, or as a basis upon which to start a gaze estimate until a complete calibration is undertaken, or for applications where accuracy of gaze estimates is not critical, or as a confirmation that a user in in fact looking at an object on a screen during a calibration. This average may be a world average or an average that fits a certain group of people who may use the device.

A method in accordance with an embodiment of the invention, may for example detect 1 degree of eye movement in an image where a diameter of an iris in an image occupies approximately 30 pixels, where the image is captured using a two dimensional camera in visible light.

1. A method comprising:
capturing with an imager and using visible light, a first two-dimensional image of an iris and a facial feature of a viewer, said imager at a known location relative to a first object on an electronic display;
capturing, using said imager, a second two-dimensional image of said iris and said facial feature; and
identifying a second object displayed on said electronic display, said second object being the subject of a gaze of said viewer.

2. The method of claim 1, wherein said display is a mobile display and said imager is a mobile imager.

3. The method as in claim 1, comprising calculating a change between said first image and said second image of a location of said iris and of a location of said facial feature.

4. The method as in claim 3, wherein said change in said location of said iris is less than a pixel of said image.

5. The method as in claim 3, comprising calculating a location of a point inside of an eye of said viewer, said point on a vector from said first object and passing through said iris.

6. The method as in claim 5, comprising calculating a location of said point inside said eye of said viewer relative to a location of said facial feature.

7. A method of identifying a point of gaze of a viewer, comprising:
identifying a location of an iris of the viewer in a two-dimensional image of the viewer, said image captured by an imager using visible light, said imager at a known location relative to an object viewed by said viewer;
calculating a location of a point inside said eye, said point on a vector from said object viewed by said user and passing though said iris;
tracking a location of an object on a face of said user;
determining a location of said point in said eye relative to said location of said object on said face of said user; and
identifying said point of gaze on a vector from said point inside said eye and passing through said iris to said point of gaze.

8. A method of identifying an object that is the subject of a gaze of a viewer, comprising:
capturing a first two-dimensional image of an iris of a user, said capturing using a single imager and visible light, and calculating a first location of said iris;
calculating a point inside an eye of a viewer, said point on a vector from an object viewed by the user passing through said iris of the user;
calculating a first location of said point inside said eye, said first location relative to a first location of a facial feature of said viewer in said first image;
detecting in a second two-dimensional image a change in location of said facial feature;
calculating a second location of said point inside said eye upon said change in said location in said facial feature, and a second location of said iris; and
identifying said object that is the subject of the gaze of the viewer, on a vector from said second location of said point inside said eye and passing through said second location of said iris.

9-10. (canceled)
